(19) United States
(12) Patent Application Publication
(10) Pub. No.: US 2022/0024002 A1
(43) Pub. Date: Jan. 27, 2022

(54) HAMMERHEAD STRIKING WRENCH

(71) Applicant: SNAP-ON INCORPORATED, Kenosha, WI (US)

(72) Inventors: Kenneth B. MONSON, Bristol, WI (US); Mark T. GORDON, Union Grove, WI (US); Mark W. EDMUNDS, Wind Point, WI (US)

(21) Appl. No.: 17/370,692

(22) Filed: Jul. 8, 2021

Related U.S. Application Data
(60) Provisional application No. 63/057,117, filed on Jul. 27, 2020.

(51) Int. Cl. B25B 19/00; B25B 23/00

(52) U.S. Cl. CPC B25B 19/00; B25B 23/0035

(57) ABSTRACT

A striking wrench comprising a socket with a working side designed to cooperate with a fastener and an impact side disposed on an opposite end of the working side, a handle comprising an attachment end designed to cooperate with the socket via an interference fit to form a rigid connection, and an anvil disposed at an end of the handle opposite the attachment end. The striking wrench may also include a secondary retention element designed to further secure the rigid connection, which can be a retaining ring, a pin and tunnel, or a threaded fastener.

### CROSS REFERENCE TO RELATED APPLICATIONS

This application claims the benefit of priority under 35 U.S.C. § 119(e) to U.S. Provisional Patent Application Ser. No. 63/057,117, filed on Jul. 27, 2020, the entire contents of which are incorporated by reference herein.

### TECHNICAL FIELD

The present disclosure generally relates to striking wrenches, and more specifically to a striking wrench with a crowned socket designed to be impacted in order to properly secure the striking wrench to a fastener.

### BACKGROUND

Striking wrenches traditionally include any number of wrenches that are designed to be struck with an external force, typically a hammer or other impact device, in order to transfer energy from the strike to turn a fastener. Striking wrenches, such as the conventional striking wrench shown in FIG. 1A, typically include a handle, a socket at one end of the handle for securement of the wrench to a fastener and a striking area at the opposite side of the handle which is designed to be struck with a hammer or other impact device. Traditionally, a striking wrench is held near the center of the wrench with one hand and struck with a hammer on the hammer-end of the wrench. The impact provided by the hammer generates large torsional forces to tighten or loosen a fastener.

In the conventional scenario, a fastener includes a nut that is threaded to a bolt. Ideally, the fastener will be clean and free of debris. However, such an ideal scenario is not always the case. In many instances, the fastener may be corroded with rust, covered in paint, or otherwise coated in dirt or other debris. In such a case, it may be difficult to secure the wrench socket to the fastener. This may lead to the striking wrench not being fully inserted onto the fastener. Use of a striking wrench when the wrench is not fully inserted onto the fastener greatly increases the risk that the wrench will become disengaged from the fastener during use, posing a serious risk to the operator.

Conventional solutions include various methods of urging the socket of a striking wrench into alignment with the fastener. Typically, the wrench or an intermediate object is impacted at an area opposite the socket so as to drive the socket down onto the fastener. Such solutions include welding a separate wrench handle to a rectangular plate, which is then positioned against the striking wrench and struck. While cost effective, this solution puts undue stress on the weld joint between the wrench handle and the rectangular plate, which can result in catastrophic failure wherein the wrench handle sheers off from the rectangular plate. Alternately, a separate wrench handle may be welded directly inside the female socket of the striking wrench, as shown in FIG. 1B. This, however, exposes the weld to stresses associated with striking the wrench handle in order to urge the striking wrench onto the fastener. Striking on the weld, in addition to areas of stress caused by differential cooling within the weld, may result in brittle failure conditions. During operation, these brittle failures may cause portions of the striking wrench to shear from the wrench itself, leading to wrench fragments being propelled toward the operator during use and increasing the risk of injury to the operator.

Non-welded solutions include a wrench handle being loosely assembled and retained within a female socket of the striking wrench. This configuration, however, is inefficient because the input force is not completely transferred from the striking end of the wrench handle to the fastener due to the reactionary forces within the loose connection. Another non-welded solution includes the use of external square drives that are capable of mating with multiple socket attachments, as shown in FIG. 1C. While versatile, this configuration has a much lower torque rating as the force is transferred through the square drive which has a much smaller cross-section than other configurations.

Use of a custom-built forged wrench may also be possible, such as the striking wrench shown in FIG. 1D. However, such a tool requires custom molds to be built, which necessitates significant up-front capital investment.

Accordingly, there is a need for a method and device for securement of a striking wrench to a fastener that can be economically manufactured, does not compromise the structural integrity of the wrench, and efficiently transfers the striking force to the fastener.

### SUMMARY

According to certain aspects of the present disclosure, a system and method of operation of striking wrenches, specifically those that have potential of being impacted on the wrenching end of the striking wrench (that is, the non-striking end) in order to properly secure the striking wrench to a fastener is provided. The striking wrench of a preferred embodiment has a socket, a handle, and an anvil. The socket is ideally connected via a non-welded rigid attachment method, such that power transfer from a striking end of the socket is efficiently transferred toward the fastener being tightened or loosened. A further object of the invention is to provide a method of manufacturing the striking wrench so as to maintain proper power transfer from the striking end of the socket to the fastener, while also minimizing production costs.

Specifically, the present disclosure relates to a striking wrench that includes a socket, a handle, and an anvil (e.g., a portion for striking). The handle and socket of the striking wrench are rigidly connected by an interference fit and a secondary retention.

In some embodiments, the interference fit may comprise a press-fit between the handle and socket of the striking wrench.

In some embodiments, the interference fit may comprise heating or cooling assembly methods.

In some embodiments, the interference fit may comprise shims and/or pins that are pressed between the handle and socket of the striking wrench.

In some embodiments, the secondary retaining method may comprise a retaining ring.

In some embodiments, the secondary retaining method may comprise pinning the handle to the socket or vice versa.

In some embodiments, the secondary retaining method may comprise a threaded fastener.

The present disclosure also covers a method of securing the striking wrench to a fastener, which includes the steps of at least partially securing the working side of the socket to the fastener, striking a crowned side of the socket, opposite the working side of the socket, until the striking wrench is properly secured in/on the fastener, and then striking the anvil of the striking wrench to loosen or tighten the fastener.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1A is a perspective view of a conventional striking wrench.

FIG. 1B is a perspective view of another conventional striking wrench.

FIG. 1C is a perspective view of yet another conventional striking wrench.

FIG. 1D is a perspective view of still another conventional striking wrench.

FIG. 2A is a perspective view of an embodiment of the striking wrench in accordance with the present disclosure.

FIG. 2B is an exploded view of an embodiment of the striking wrench in accordance with the present disclosure.

FIG. 2C is a cross-sectional side view of an embodiment of the striking wrench in accordance with the present disclosure.

FIG. 2D is a cross-sectional side view of an alternate embodiment of the striking wrench in accordance with the present disclosure.

FIG. 2E is a perspective view of an alternate embodiment of the striking wrench in accordance with the present disclosure.

FIG. 2F is a cross-sectional side view of an alternate embodiment of the striking wrench in accordance with the present disclosure.

FIG. 2G is a top view of an embodiment of the striking wrench in accordance with the present disclosure.

FIG. 3A is a perspective view of an alternate embodiment of the striking wrench in accordance with the present disclosure.

FIG. 3B is an exploded view of an alternate embodiment of the striking wrench in accordance with the present disclosure.

FIG. 3C is a cross-sectional side view of an alternate embodiment of the striking wrench in accordance with the present disclosure.

FIG. 3D is a perspective view of an alternate embodiment of the striking wrench in accordance with the present disclosure.

FIG. 3E is a cross-sectional side view of an alternate embodiment of the striking wrench in accordance with the present disclosure.

FIG. 3F is a top view of an alternate embodiment of the striking wrench in accordance with the present disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

In addition, each of the drawings is a schematic diagram and thus is not necessarily strictly illustrated. In each of the drawings, substantially the same structural components are assigned with the same reference signs, and redundant descriptions will be omitted or simplified.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. For example, while the striking wrenches discussed herein may be implemented in many different forms, the disclosure will show in the drawings, and will herein describe in detail, implementations with the understanding that the present description is to be considered as an exemplification of the principles of the striking wrench and is not intended to limit the broad aspects of the disclosure to the implementations illustrated. Accordingly, the drawings and description are to be regarded as illustrative in nature and not restrictive.

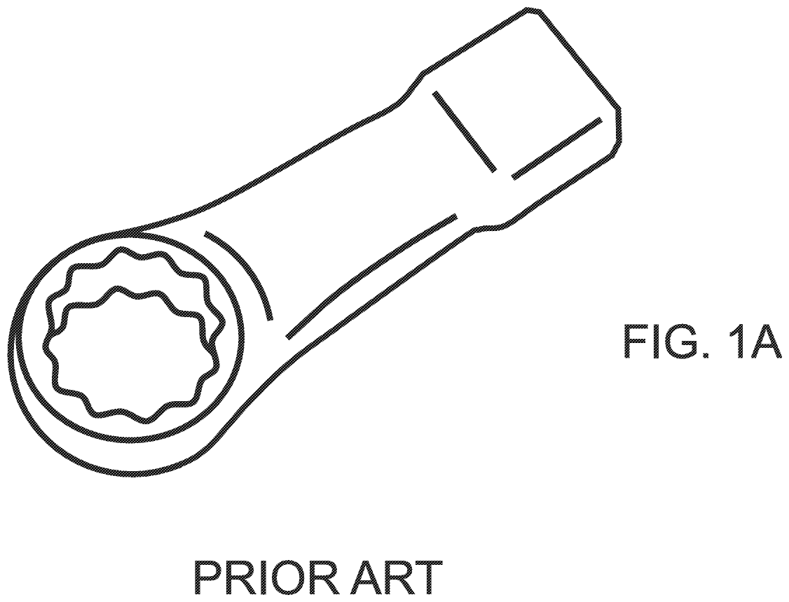

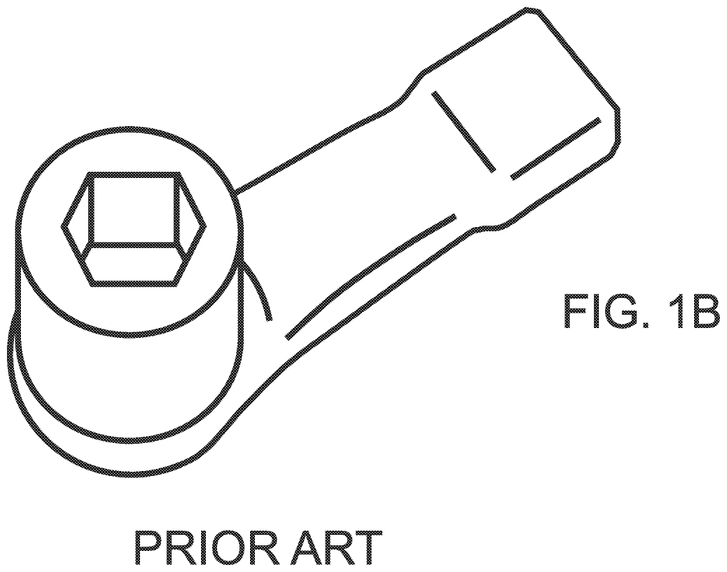

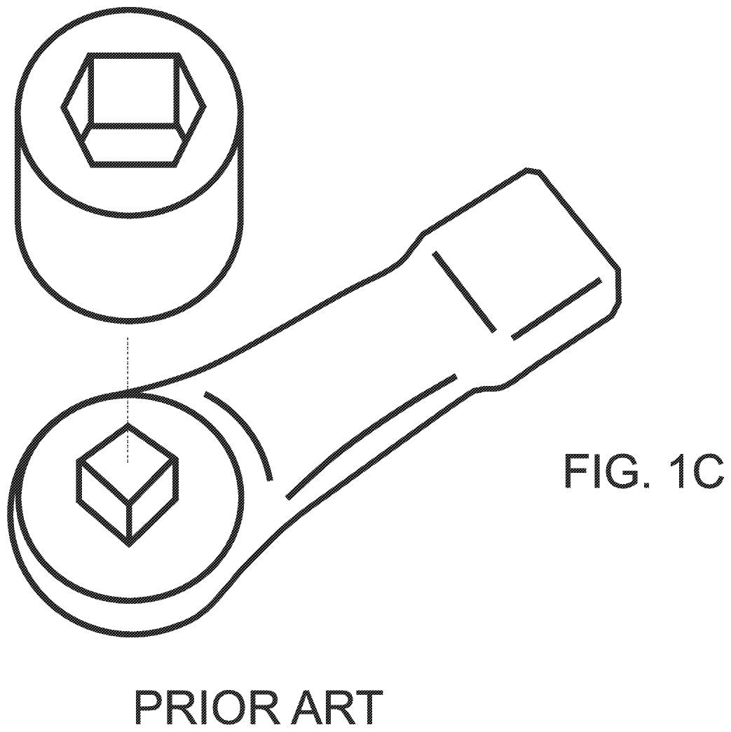

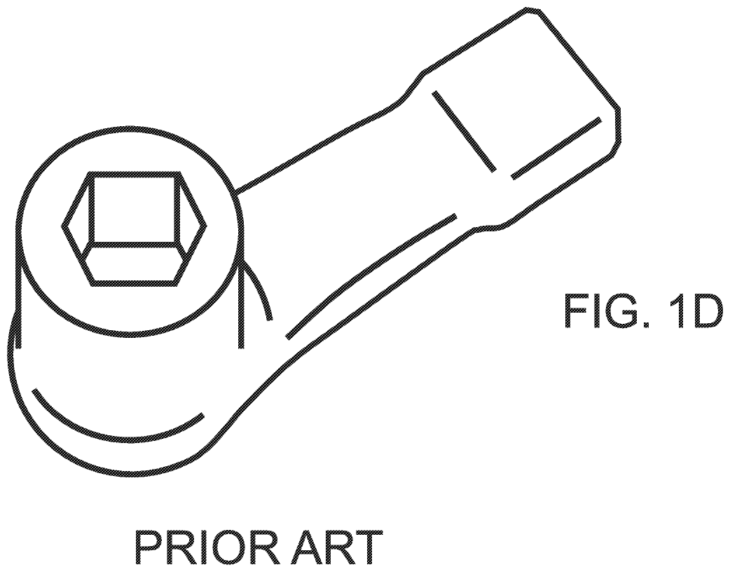

FIG. 1A shows a conventional striking wrench having a socket, handle, and anvil. In conventional use, an operator fits the socket of the striking wrench to a fastener. In order to maintain stability of the striking wrench on the fastener, the operator may hold the striking wrench at the handle during operation. The operator may employ a striking wrench retainer accessory. The operator then strikes the anvil of the striking wrench, at or around an impact surface of the anvil, with a hammer or other impact object. The impact provided by the hammer generates a large torsional force that is transferred to the fastener in order to tighten or loosen the fastener. The striking wrench socket typically includes a number of teeth designed to grip a fastener.

A conventional fastener assembly comprises a nut that is generally hexagonal in shape, when viewed from a top view. Other shaped fasteners are also anticipated. The nut has a threaded inner channel which cooperates with inverse threading on an exterior perimeter of a bolt. As the nut is rotated about the bolt, the interlocking threading causes the nut to move in a downward direction toward a securement surface, thus tightening the bolt to the securement surface. Rotating the nut about the bolt in an opposite direction causes the nut to move in an upward direction, away from the securement surface, thus loosening the bolt from the securement surface. Fasteners are typically comprised of metal, though other materials are contemplated.

In an ideal scenario, the fastener will be clean and free of rust, paint, and other debris. Such is typically the case when the fastener is first installed. However, such an ideal scenario is not always the case. In many instances, such as where fasteners are installed outside for long periods of time, the fastener may be corroded with rust. Additionally, fasteners may be painted after installation, sometimes with multiple coats of paint. In such a scenario, it may be difficult to secure the wrench socket to the fastener, as the dimensions of the nut may have changed due to the layers of paint, rust, or other debris. This scenario may lead to the striking wrench not being fully inserted onto the fastener. Use of a striking wrench when the wrench is not fully inserted onto the fastener greatly increases the risk that the wrench will become disengaged from the fastener during use, posing a serious risk to the operator.

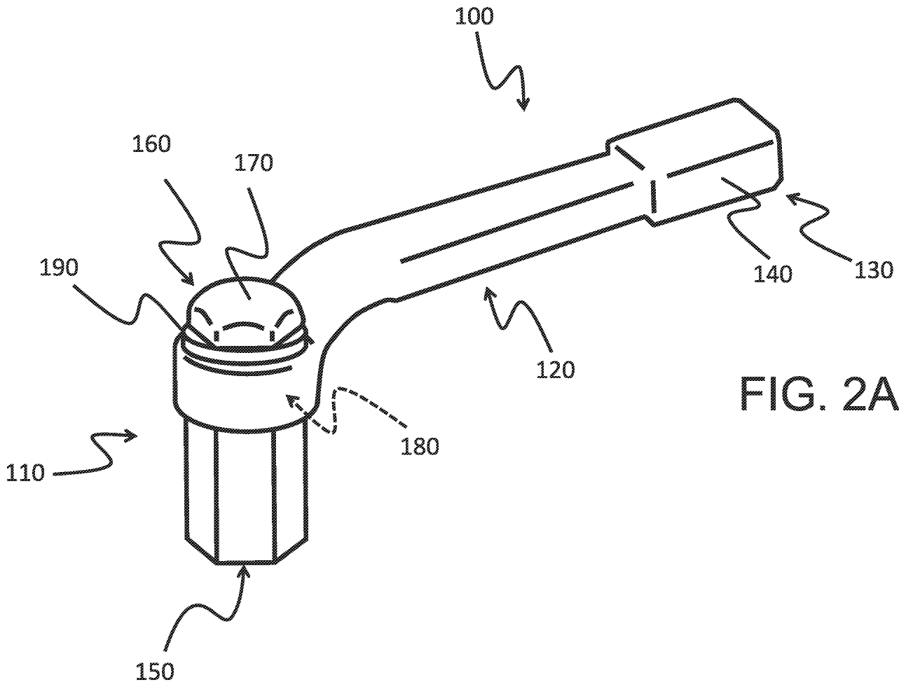

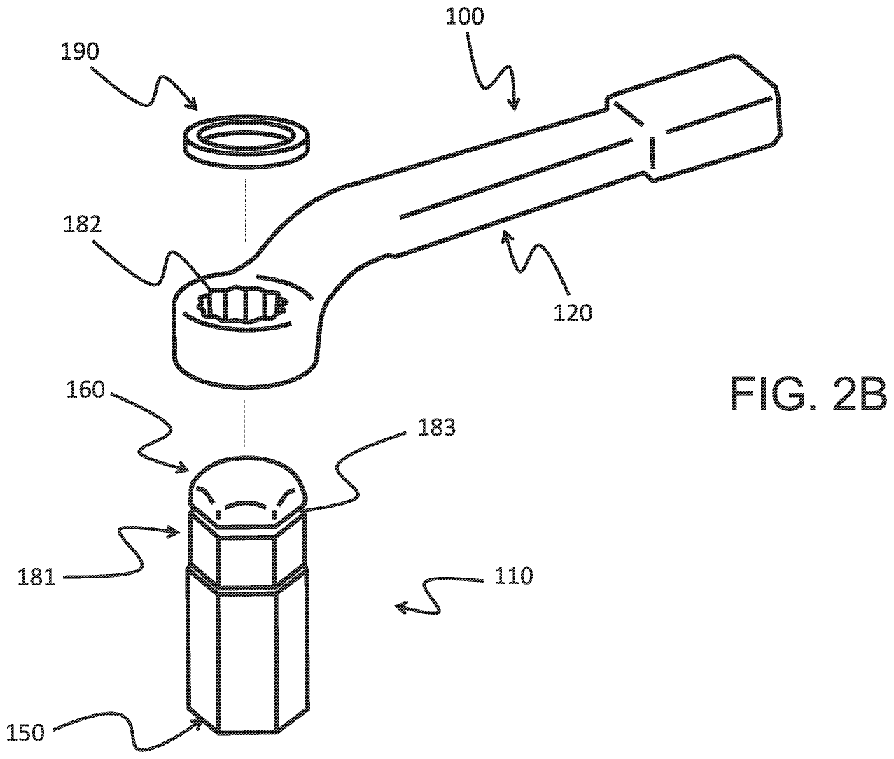

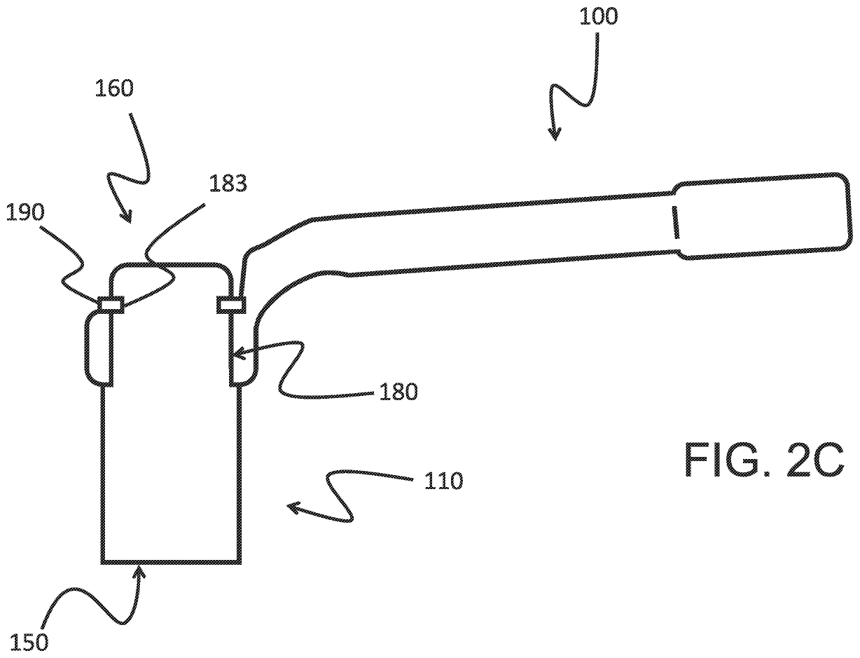

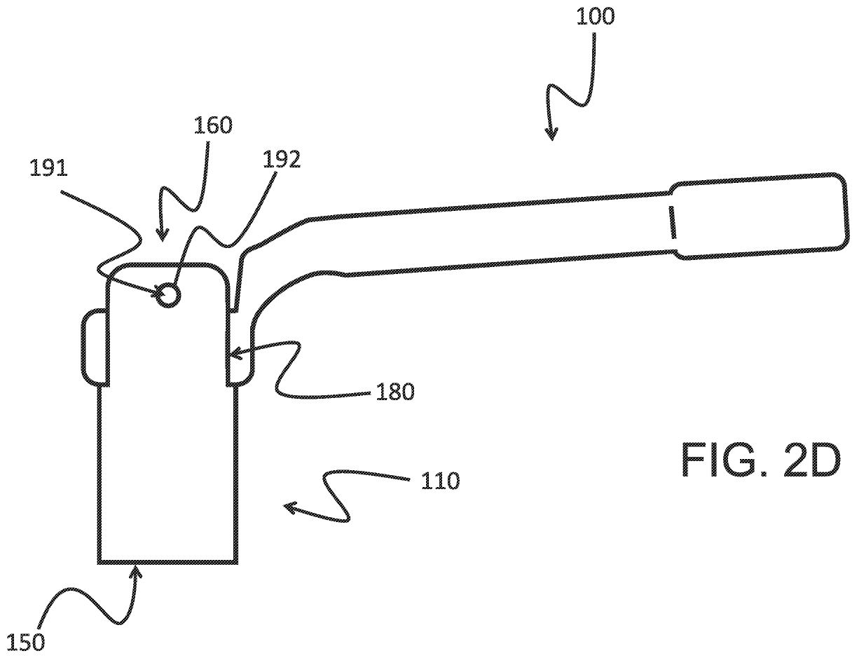

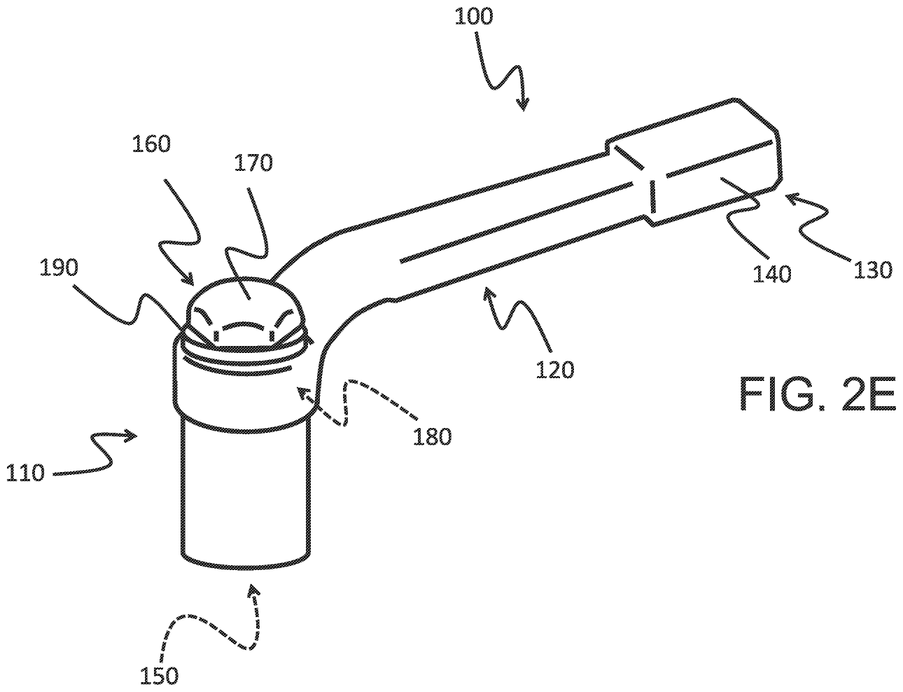

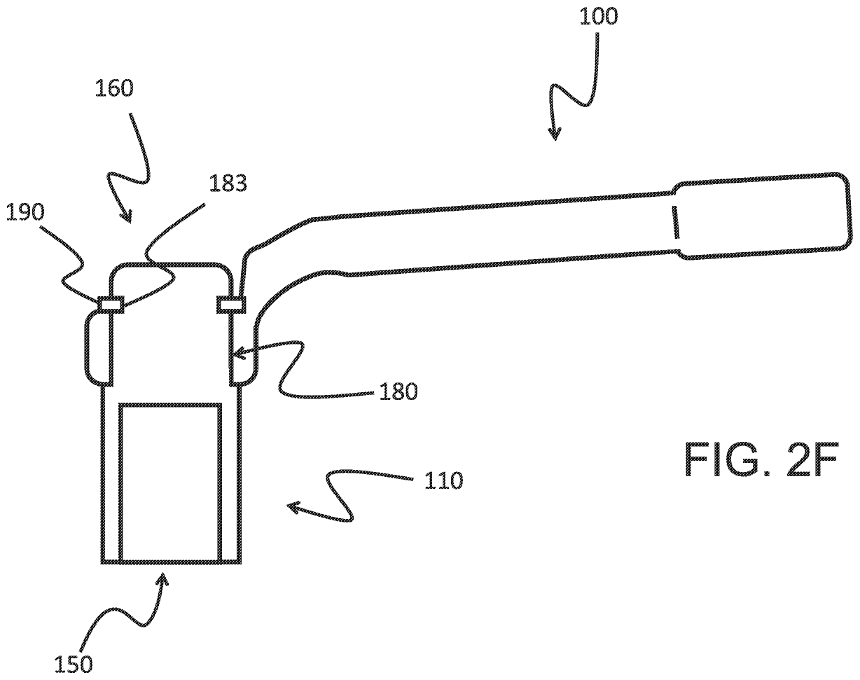

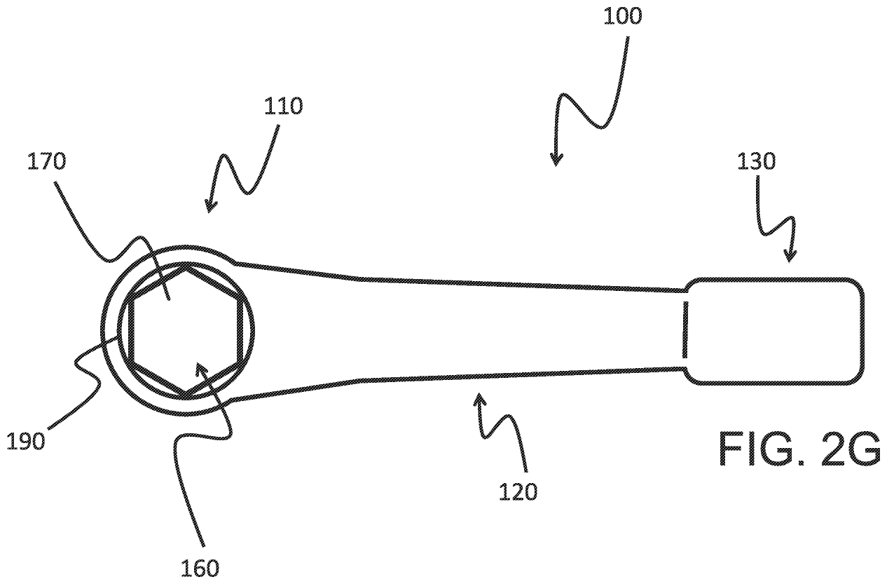

FIGS. 2A-2G show aspects of embodiments of the present disclosure. As illustrated in FIGS. 2A-2G, a striking wrench 100 may include a socket 110, a handle 120, and an anvil 130 with an impact surface 140.

The socket 110 of the striking wrench 100 has a working side 150 that can be secured in/around the fastener and a crowned end 160 that provides an impact surface 170 for striking the striking wrench to secure the socket to the fastener. The socket may have an external shape matching that of the working end of the handle 120 so that the socket 110 can be rigidly connected to the handle 120. The rigid connection between the socket 110 and handle 120 may be obtained by an interference fit 180. The rigid connection may also include a secondary retention. For example, the rigid connection between the socket 110 and handle 120 may additionally be secured by a retention ring 190 around the crowned end 160 of the socket 110 to thereby further retain the socket 110 within the working end of the handle 120.

In practice, the striking wrench 100 is at least partially positioned on the fastener. The striking wrench 100 may then be impacted on the impact surface 170 of the crowned end 160 of the socket 110 by a hammer or other impacting tool. The force of the impact may drive the working side 150 of the socket 110 further into/onto the fastener. This may be repeated until the striking wrench 100 is sufficiently secured to the fastener. The striking wrench 100 may then be impacted one or more times on the impact surface 140 of the anvil 130 in order to tighten or loosen the fastener.

FIG. 2B shows an exploded view of a striking wrench 100 according to the present disclosure. As illustrated in FIG. 2B, the perimeter of the socket 110 may be hexagonal, though other shapes are anticipated. The hexagonal perimeter of the socket 110 may have a fitting portion 181, with a smaller width than that of the working side 150 of the socket 110, for the interference fit 180 with the working end of the handle 120.

The socket 110 is preferably connected to the handle 120 via a non-welded rigid attachment method, such that the striking force is efficiently transferred from the anvil 130 through the handle 120 to the socket 110. The rigid attachment method may be accomplished via an interference fit 180 between the socket 110 of the striking wrench 100 and the handle 120.

As shown in FIGS. 2A-2G, the interference fit 180 between the socket 110 and handle 120 is accomplished via a press-fit. In other embodiments, the interference fit 180 may be accomplished via heating or cooling assembly methods. For example, prior to affixation, the handle 120 may be heated such that it expands slightly in order to receive the socket 110. Once the socket 110 is fit into the handle 120, the handle 120 is allowed to cool and contract around the socket 110, thus forming a secure fit. Alternately, socket 110 may be cooled such that it shrinks slightly, after which the cooling method is removed and socket 110 it is fit into handle 120. As socket 110 warms from its cooling state, it expands, forming a secure fit to handle 120. In alternate embodiments, the interference fit 180 may be accomplished by pins and/or shims wedged between the socket 110 and handle 120, thus forming a secure interference fit.

Additionally, a secondary form of retention may be provided to further secure the socket 110 and the handle 120. For example, FIGS. 2A-2C illustrate an embodiment with a retaining ring 190 that may provide additional securement between the socket 110 and the handle 120. With reference to FIG. 2B, the socket 110 may contain a channel 183 between the crowned end 160 and the fitting portion 181 which may span some or all of a perimeter of the socket 120. The channel 183 may be positioned such that when the socket 110 is fully secured within the handle 120 of the striking wrench 100, a bottom of the channel 183 (that is, the inner side closest to the working side 150 of the socket 110) is generally flush with a top of the opening 182 of the handle 120 (that is, the side of the opening of the handle 120 away from the working side 150 of the socket 110). This positioning allows for a retention ring 190 to be secured in the channel 183, thus adding to the retention of the socket 110 to the handle 120 of the striking wrench 100. FIG. 2C is a cross section of the striking wrench 100, and shows an inner circumference of the retention ring 190 may have generally the same circumference as an inside of the channel 183 and shows an outer circumference of the retention ring 190 protruding from the channel 183 such that the socket 110 is locked in the handle 120 of the striking wrench 100. In other embodiments, the channel may be a threaded groove and the retaining ring may contain internal threading that mates with the threaded grove of the socket 110.

In other embodiments, as shown in FIG. 2D, the secondary retention may be from a pin 191 that locks the socket 110 to the handle 120. Specifically, the crowned side 160 of the socket 110 that protrudes from the handle 120 may include a tunnel 192 that has a bottom side generally flush with the top side of the opening of the handle 120 of the striking wrench 100 such that when a pin 191 is positioned in or through the tunnel 192, the socket 110 is locked into the handle 120. The pin may be a cotter pin, for example, or any other type of pin.

As shown in FIGS. 2A-2D, working side 150 is a male bit that fits inside the head of a fastener. The male bit may be a multi-sided hex bit which cooperates with a hex recess in the head of a fastener. Other shapes are also anticipated such as those designed to mate with a square, star, Torx®, or other recess in the head of a fastener. In alternate embodiments, such as those shown in FIGS. 2E-2F, working side 150 is a female socket with an internal recess designed to fit over the head of a fastener. The internal recess may be in the shape of a hex recess in order to fit over the head of a hex fastener. Other shapes are also anticipated such as those designed to mate with square headed or other types of fasteners.

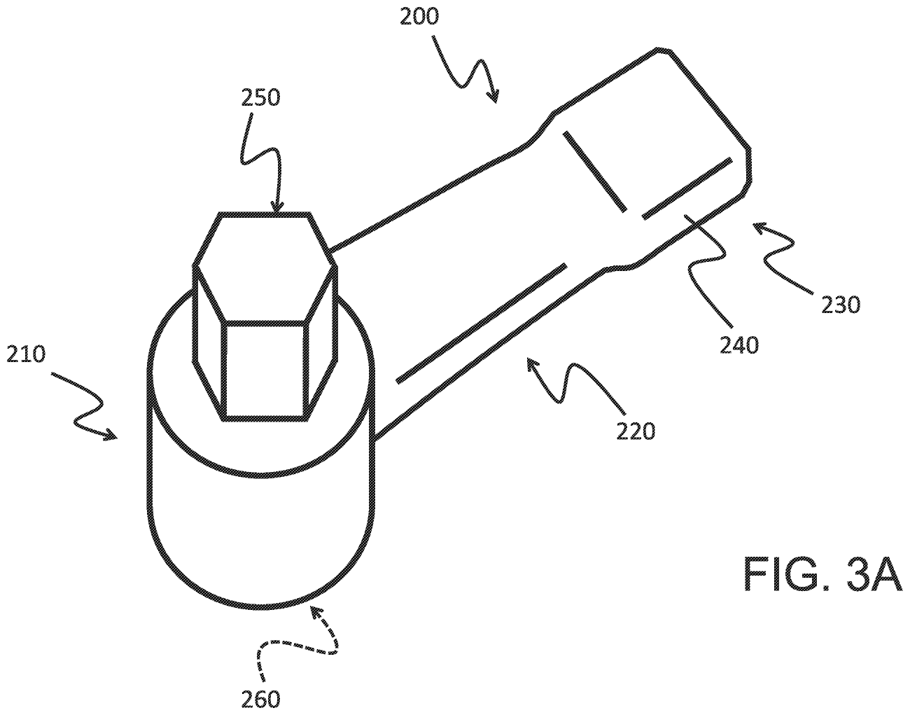

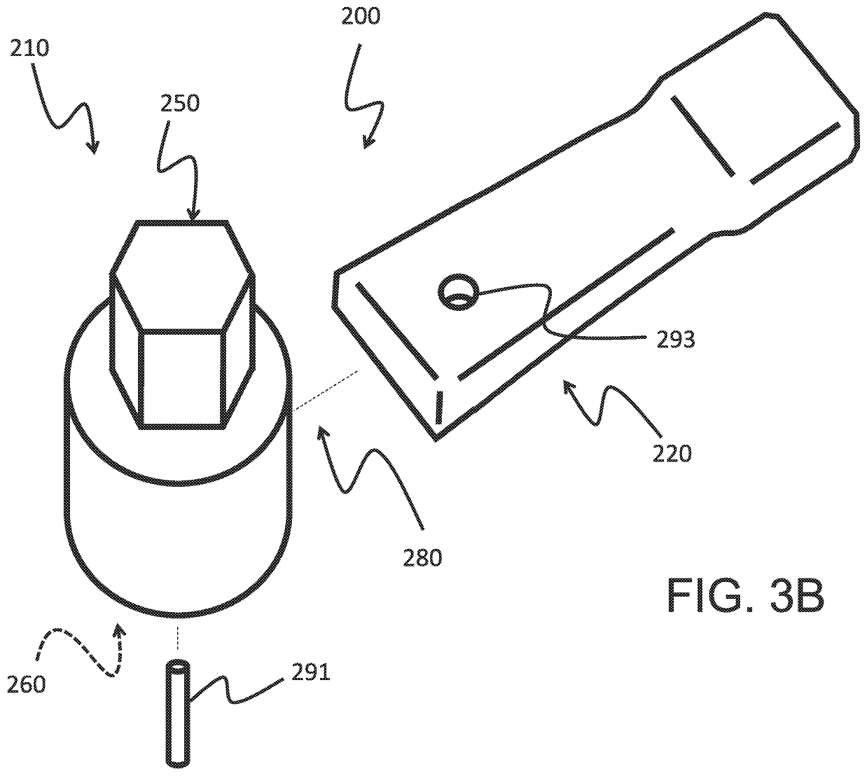

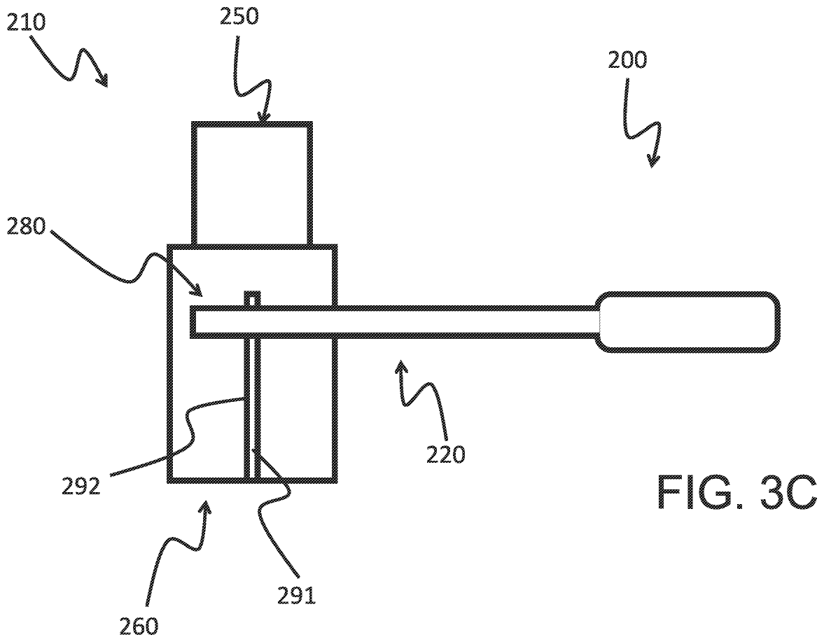

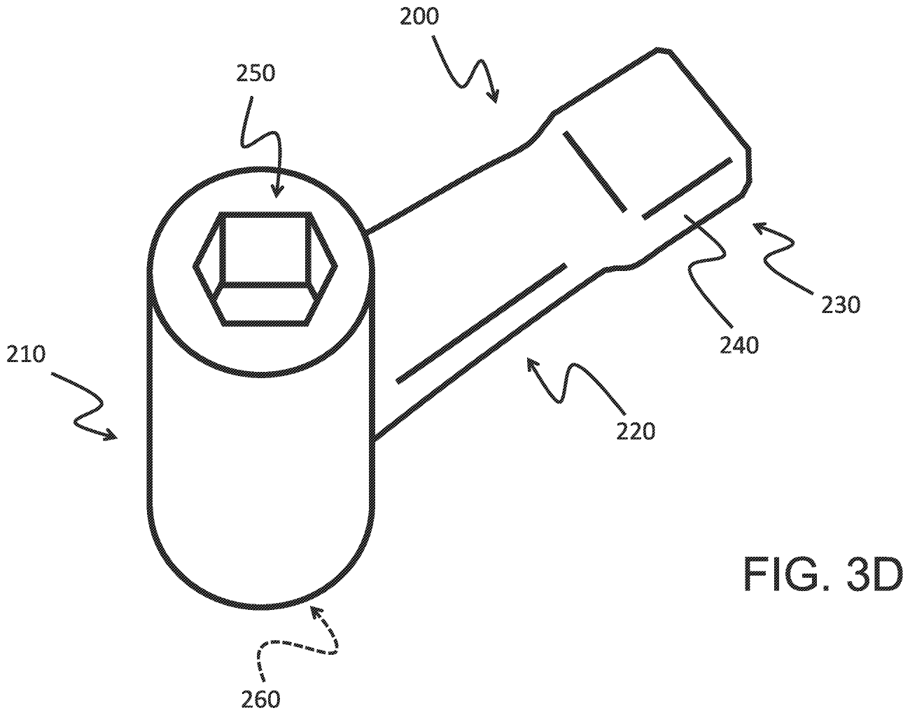

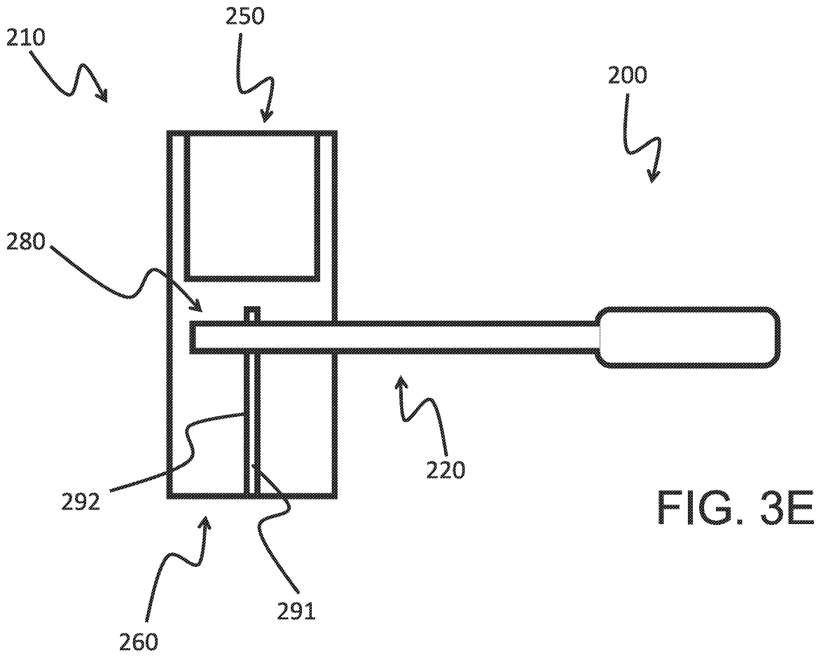

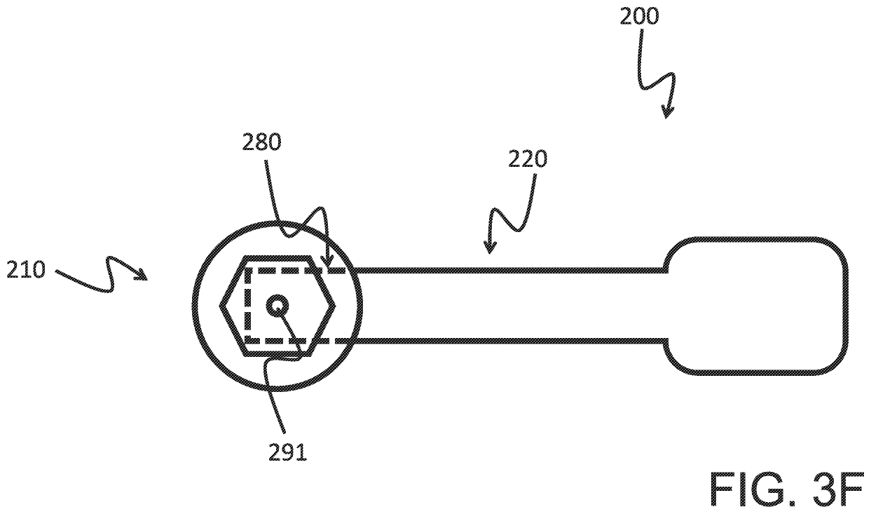

FIGS. 3A-3F show another embodiment of the present disclosure which includes a striking wrench 200 including a socket 210, a handle 220, and an anvil 230 with an impact surface 240. The socket 210 has a working side 250 that can be secured around the fastener and has an opposing side 260 that provides an impact surface for striking the striking wrench to secure the socket to the fastener.

As shown in FIGS. 3B-3C, the socket 210 is secured to handle 220 by interference fit 280. Specifically, the socket 210 includes a recess that is slightly larger than the handle 220 so that the socket 210 can receive the handle 220 of the striking wrench 200.

FIGS. 3B-3C show the secondary retention provided by a pin 291 inserted into a tunnel 292 of the socket 210 of the striking wrench 200. FIG. 3C is a cross sectional view of striking wrench 200 and shows that when handle 220 is positioned within the recess of socket 210, a hole 293 in the handle 220 aligns with a tunnel 292 in the socket 210. Upon alignment of the hole 293 with the tunnel 292, a pin 291 may be positioned such that it extends into the tunnel 292 of the socket 210 and into or through the hole 291 of the handle 220.

As shown in FIGS. 3A-3C, working side 250 is a male bit that fits inside the head of a fastener. The male bit may be a multi-sided hex bit which cooperates with a hex recess in the head of a fastener. Other shapes are also anticipated such as those designed to mate with a square, star, Torx®, or other recess in the head of a fastener. In alternate embodiments, such as those shown in FIGS. 3D-3E, working side 250 is a female socket with an internal recess designed to fit over the head of a fastener. The internal recess may be in the shape of a hex recess in order to fit over the head of a hex fastener. Other shapes are also anticipated such as those designed to mate with square headed or other types of fasteners.

As reflected by the embodiments described above, the present disclosure contemplates that the socket may be fit within the handle (as shown in the embodiments of FIGS. 2A-2G) or the handle may be fit within the socket (as shown in the embodiments of FIGS. 3A-3F). The interference fit may be one or more of a press-fit, a heating and/or cooling assembly method, or shims and/or pins, but is not limited thereto. The secondary retention may be one or more of a retaining ring, one or more pins, or a threaded fastening, but is not limited thereto.

While some implementations have been illustrated and described, numerous modifications come to mind without significantly departing from the spirit of the disclosure, and the scope of protection is only limited by the scope of the accompanying claims. Terms such as “top,” “bottom,” “front,” “rear,” “upper,” “lower,” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single product or packaged into multiple products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

The disclosed systems and methods are well adapted to attain the ends and advantages mentioned as well as those that are inherent therein. The particular implementations disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative implementations disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each article of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A striking wrench comprising:
a socket comprising a working side designed to cooperate with a fastener and an impact side disposed on an opposite end of the working side;
a handle comprising an attachment end designed to cooperate with the socket via an interference fit to form a rigid connection; and
an anvil disposed at an end of the handle opposite the attachment end.

2. The striking wrench of claim 1, further comprising a secondary retention element designed to further secure the rigid connection.

3. The striking wrench of claim 2, wherein the secondary retention element comprises a retaining ring.

4. The striking wrench of claim 2, wherein the secondary retention element comprises a pin and tunnel.

5. The striking wrench of claim 2, wherein the secondary retention element comprises a threaded fastener.

6. The striking wrench of claim 1, wherein the interference fit comprises a press-fit.

7. The striking wrench of claim 1, wherein the interference fit comprises one or more shims wedged between an inner surface of an opening in the attachment end and an outer surface of the socket.

8. A method for using a striking wrench comprising:
securing a socket to a handle via an interference fit to form a rigid connection, the socket comprising a working side designed to cooperate with a fastener and an impact side disposed on an opposite end of the working side, and the handle comprising an attachment end designed to cooperate with the socket;
at least partially securing the working side of the socket to a fastener;
striking the impact side of the socket to secure the working side of the socket to the fastener; and
striking an anvil disposed at an end of the handle opposite the attachment end to loosen or tighten the fastener.

9. The method of claim 8, further comprising affixing a secondary retention element designed to further secure the rigid connection.

10. The method of claim 9, wherein the secondary retention element comprises a retaining ring.

11. The method of claim 9, wherein the secondary retention element comprises a pin and tunnel.

12. The method of claim 9, wherein the secondary retention element comprises a threaded fastener.

13. The method of claim 8, wherein the interference fit comprises a press-fit.

14. The method of claim 8, wherein the interference fit comprises one or more shims wedged between an inner surface of an opening in the attachment end and an outer surface of the socket.

15. A striking wrench system comprising:
a socket comprising a working side designed to cooperate with a fastener and an impact side disposed on an opposite end of the working side;
a handle comprising an attachment end designed to cooperate with the socket via an interference fit to form a rigid connection;
an anvil disposed at an end of the handle opposite the attachment end; and
a secondary retention element designed to further secure the rigid connection.

16. The system of claim 15, wherein the secondary retention element comprises a retaining ring.

17. The system of claim 15, wherein the secondary retention element comprises a pin and tunnel.

18. The system of claim 15, wherein the secondary retention element comprises a threaded fastener.

19. The system of claim 15, wherein the interference fit comprises a press-fit.

20. The system of claim 15, wherein the interference fit comprises one or more shims wedged between an inner surface of an opening in the attachment end and an outer surface of the socket.
